(19) United States
(12) Patent Application Publication
(10) Pub. No.: US 2022/0204777 A1
(43) Pub. Date: Jun. 30, 2022

(54) Method Of Producing Coloring Material Dispersion

(71) Applicant: Seiko Epson Corporation, Tokyo (JP)

(72) Inventors: Harunobu KOMATSU, Matsumoto (JP); Toshihiro OTAKE, Chino (JP); Hiroshi ITO, Matsumoto (JP); Koji HORIBA, Matsumoto (JP)

(21) Appl. No.: 17/560,604

(22) Filed: Dec. 23, 2021

(30) Foreign Application Priority Data
Dec. 25, 2020 (JP) 2020-218026

(51) Int. Cl. C09B 67/46; C09B 69/10; C09D 11/328

(52) U.S. Cl. CPC C09B 67/0084; C09D 11/328; C09B 69/109

(57) ABSTRACT

A method of producing a coloring material dispersion is a method of producing a coloring material dispersion that contains water and a coloring material, including a polymerization step of performing a polymerization reaction in a liquid phase that contains an organic solvent containing two or more hydroxyl and/or ether groups in a molecule, a hydrophobic monomer having an aromatic ring or a (meth)acrylic acid alkyl ester structure, and a hydrophilic monomer containing a carboxylic acid group or a sulfonic acid group to synthesize a dispersion resin. The dispersion resin has a weight-average molecular weight of 5,000 or greater and less than 100,000. A content of a constituent unit A corresponding to the hydrophobic monomer in all constituent monomers contained in the dispersion resin is 50 mol % or greater.

The present application is based on, and claims priority from JP Application Serial Number 2020-218026, filed Dec. 25, 2020, the disclosure of which is hereby incorporated by reference herein in its entirety.

### BACKGROUND

### 1. Technical Field

The present disclosure relates to a method of producing a coloring material dispersion.

### 2. Related Art

A coloring material dispersion in which a coloring material, such as a pigment or a disperse dye, is dispersed is used as, for example, an ink jet ink. In such a coloring material dispersion, the coloring material is required to have excellent dispersibility, and the coloring material dispersion is required to have excellent storage stability.

For such purposes, an aqueous pigment dispersion containing a pigment, a pigment dispersion resin, a basic compound, and water and satisfying a predetermined parameter has been suggested (see JP-A-2017-226760).

JP-A-2017-226760 discloses, as a method of producing such an aqueous pigment dispersion, a method of sequentially performing a step of dispersing a pigment in a non-aqueous solvent by using a pigment dispersion resin synthesized by polymerizing lauryl methacrylate, styrene, and acrylic acid in methyl ethyl ketone, a step of removing the non-aqueous solvent, a step of adding a basic compound and water thereto and mixing and stirring the dispersion, and a step of irradiating the dispersion with ultrasonic waves.

However, in the above-described method, there is a problem in that a dispersed state of a coloring material is difficult to stably maintain for a long time, and an ink to which this method has been applied exhibits non-Newtonian properties and poor redispersibility after solidification and is thus likely to induce, for example, ejection failure in an ink jet method.

### SUMMARY

The present disclosure has been made to solve the above-described problem and can be realized as the following aspect.

According to an aspect of the present disclosure, there is provided a method of producing a coloring material dispersion that contains water and a coloring material. The method includes a polymerization step of performing a polymerization reaction in a liquid phase that contains an organic solvent containing two or more hydroxyl and/or ether groups in a molecule, a hydrophobic monomer having an aromatic ring or a (meth)acrylic acid alkyl ester structure, and a hydrophilic monomer containing a carboxylic acid group or a sulfonic acid group to synthesize a dispersion resin. The dispersion resin has a weight-average molecular weight of 5,000 or greater and less than 100,000. A content of a constituent unit A corresponding to the hydrophobic monomer in all constituent monomers contained in the dispersion resin is 50 mol % or greater.

In the method of producing a coloring material dispersion according to the aspect of the present disclosure, the organic solvent may be at least one selected from the group consisting of glycol ethers and polyhydric alcohols.

In the method of producing a coloring material dispersion according to the aspect of the present disclosure, both the hydrophobic monomer and the hydrophilic monomer may have a polymerizable double bond.

In the method of producing a coloring material dispersion according to the aspect of the present disclosure, the hydrophobic monomer may be at least one selected from the group consisting of butyl (meth)acrylate and styrene.

In the method of producing a coloring material dispersion according to the aspect of the present disclosure, the hydrophilic monomer may be at least one selected from the group consisting of vinylsulfonic acid, (meth)acrylic acid, (meth)allylsulfonic acid, 2-acrylamido-2-methylpropanesulfonic acid, and salts thereof.

In the method of producing a coloring material dispersion according to the aspect of the present disclosure, a content of a constituent unit B corresponding to the hydrophilic monomer in all constituent monomers contained in the dispersion resin may be 1 mol % or greater and 50 mol % or less.

In the method of producing a coloring material dispersion according to the aspect of the present disclosure, the dispersion resin may have a dispersity of 1.05 or greater and less than 2.50.

In the method of producing a coloring material dispersion according to the aspect of the present disclosure, the dispersion resin may have a weight-average molecular weight of 7,000 or greater and less than 60,000.

In the method of producing a coloring material dispersion according to the aspect of the present disclosure, the coloring material may be a disperse dye.

The method of producing a coloring material dispersion according to the aspect of the present disclosure may further include a water mixing step of mixing the dispersion resin with the water.

The method of producing a coloring material dispersion according to the aspect of the present disclosure may further include a coloring material mixing step of mixing the dispersion resin with the coloring material.

The method of producing a coloring material dispersion according to the aspect of the present disclosure may further include a coloring material crushing step of crushing the coloring material in a liquid containing the water, the coloring material, and the dispersion resin.

The method of producing a coloring material dispersion according to the aspect of the present disclosure may further include an ink preparation step of mixing a liquid composition obtained by the coloring material crushing step with water and an organic solvent containing two or more hydroxyl and/or ether groups in a molecule to obtain a coloring material dispersion used as an ink for ink jet recording.

### DESCRIPTION OF EXEMPLARY EMBODIMENTS

Hereinafter, preferred embodiments of the present disclosure will be described in detail.

### [1] Method of Producing Coloring Material Dispersion

First, a method of producing a coloring material dispersion according to the present disclosure will be described.

The method of producing a coloring material dispersion according to the present disclosure is a method of producing a coloring material dispersion that contains water and a coloring material. The method includes a polymerization step of performing a polymerization reaction in a liquid phase that contains an organic solvent containing two or more hydroxyl and/or ether groups in a molecule, a hydrophobic monomer having an aromatic ring or a (meth)acrylic acid alkyl ester structure, and a hydrophilic monomer containing a carboxylic acid group or a sulfonic acid group to synthesize a dispersion resin. Further, the dispersion resin has a weight-average molecular weight of 5,000 or greater and less than 100,000, and the content of a constituent unit A corresponding to the hydrophobic monomer in all constituent monomers contained in the dispersion resin is 50 mol % or greater.

In this manner, a method of producing a coloring material dispersion which enables production of a coloring material dispersion having a coloring material with excellent dispersion stability and with excellent redispersibility after solidification can be provided. Therefore, the coloring material dispersion produced using the method of producing a coloring material dispersion according to the present disclosure has excellent long-term storability and also has excellent ejection stability in an ink jet method when the coloring material dispersion is applied to an ink for ink jet recording. Further, when a solvent is added to the coloring material dispersion to obtain an ink, destruction of stable dispersion of the dispersion system can be prevented.

In the present disclosure, “coloring material dispersion” refers to a dispersion in a state where a coloring material has been dispersed in a liquid dispersion medium.

Particularly, according to the present embodiment, the method of producing a coloring material dispersion includes, in addition to the polymerization step, a water mixing step of mixing the dispersion resin with water, a coloring material mixing step of mixing the dispersion resin with a coloring material, a coloring material crushing step of crushing the coloring material in the liquid containing water, the coloring material, and the dispersion resin, and an ink preparation step of mixing the liquid composition obtained in the above-described manner with water and an organic solvent containing two or more hydroxyl and/or ether groups in a molecule to obtain a coloring material dispersion used as an ink for ink jet recording. Hereinafter, each step will be described in detail.

### [1-1] Polymerization Step

In the polymerization step, the polymerization reaction is performed in a liquid phase that contains an organic solvent containing two or more hydroxyl and/or ether groups in a molecule, a hydrophobic monomer having an aromatic ring or a (meth)acrylic acid alkyl ester structure, and a hydrophilic monomer containing a carboxylic acid group or a sulfonic acid group to synthesize a dispersion resin.

### [1-1-1] Organic Solvent

Examples of the organic solvent used in the polymerization step include those containing two or more hydroxyl and/or ether groups in a molecule.

The organic solvent functions as a solvent that dissolves the hydrophobic monomer and the hydrophilic monomer in the present step and allows the polymerization reaction to proceed more suitably as a homogeneous reaction. Further, the following effects are also obtained by using the organic solvent containing two or more hydroxyl and/or ether groups in a molecule. That is, for example, when the coloring material dispersion to be finally obtained contains the organic solvent containing two or more hydroxyl and/or ether groups in a molecule, the dispersion stability of the coloring material in the coloring material dispersion, the storage stability of the coloring material dispersion, the redispersibility of the coloring material after precipitation of the coloring material from the coloring material dispersion, and the like can be further improved.

It is preferable that such an organic solvent be at least one selected from the group consisting of glycol ethers and polyhydric alcohols.

In this manner, the above-described effects are more significantly exhibited.

Examples of glycol ethers include alkylene glycol monoethers and alkylene glycol diethers.

Examples of alkylene glycol monoethers include ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol monohexyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, dipropylene glycol monomethyl ether, and dipropylene glycol monoethyl ether.

Examples of alkylene glycol diethers include ethylene glycol dimethyl ether, ethylene glycol diethyl ether, ethylene glycol dibutyl ether, diethylene glycol dimethyl ether, diethylene glycol diethyl ether, diethylene glycol ethyl methyl ether, diethylene glycol dibutyl ether, diethylene glycol butyl methyl ether, triethylene glycol dimethyl ether, triethylene glycol diethyl ether, triethylene glycol dibutyl ether, triethylene glycol butyl methyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, and dipropylene glycol diethyl ether.

Examples of polyhydric alcohols include alkanediols such as ethylene glycol, propylene glycol, 1,3-propanediol, 1,2-butanediol, 1,3-butanediol, 1,2-pentanediol, 1,3-pentanediol, 1,4-butanediol, 2,3-butanediol, 3-methyl-1,3-butanediol, 1,5-pentanediol, 2-methyl-2,4-pentanediol, 3-methyl-1,5-pentanediol, 1,2-hexanediol, 1,6-hexanediol, 1,2-octanediol, 2-methyl-1,3-propanediol, 2,2-dimethyl-1,3-propanediol, and 2-ethyl-1,3-hexanediol, dihydric alcohols such as diethylene glycol, triethylene glycol, tetraethylene glycol, and dipropylene glycol, and trihydric alcohols such as trimethylolpropane and glycerol.

Among these, as the organic solvent, at least one selected from the group consisting of alkylene glycol monoethers and dihydric alcohols is preferable, and at least one selected from the group consisting of 1,2-butanediol, triethylene glycol monomethyl ether, and propylene glycol is more preferable.

In this manner, the above-described effects are more significantly exhibited.

Further, when the coloring material dispersion to be finally obtained contains an organic solvent, it is preferable that the same organic solvent as the organic solvent contained in the coloring material dispersion to be finally obtained be used as the organic solvent used in the present step.

In this manner, the dispersion stability of the coloring material in the coloring material dispersion to be finally obtained, the storage stability of the coloring material dispersion, the redispersibility of the coloring material after precipitation of the coloring material from the coloring material dispersion, and the like can be further improved.

The liquid phase for carrying out the polymerization reaction of polymerizing the dispersion resin may further include organic solvents other than the above-described organic solvent containing two or more hydroxyl and/or ether groups in a molecule. Examples of other organic solvents include DMF, THF, and ethanol.

The content of the organic solvent containing two or more hydroxyl and/or ether groups in a molecule in the liquid phase for carrying out the polymerization reaction is not particularly limited, but is preferably 10% by mass or greater and 70% by mass or less, more preferably 15% by mass or greater and 55% by mass or less, and still more preferably 18% by mass or greater and 40% by mass or less with respect to the total content of the organic solvent, the hydrophobic monomer, and the hydrophilic monomer in the liquid phase for carrying out the polymerization reaction.

Further, the content of the organic solvent containing two or more hydroxyl and/or ether groups in a molecule is preferably 30% by mass or greater and more preferably 50% by mass or greater with respect to the total amount of the organic solvents including other organic solvents.

In this manner, the polymerization reaction can proceed more suitably, and the dispersion stability of the coloring material in the coloring material dispersion to be finally obtained, the storage stability of the coloring material dispersion, the redispersibility of the coloring material after precipitation of the coloring material from the coloring material dispersion, and the like can be further improved.

### [1-1-2] Hydrophobic Monomer

The hydrophobic monomer used in the polymerization step is a compound having an aromatic ring or a (meth)acrylic acid alkyl ester structure in a molecule.

The form of polymerization of the hydrophobic monomer is not particularly limited as long as the hydrophobic monomer has the above-described chemical structure. Examples of the form of polymerization of the hydrophobic monomer include addition polymerization, condensation polymerization, and ring-opening polymerization. Among these, addition polymerization is preferable, and a hydrophobic monomer having a polymerizable double bond is preferable as the hydrophobic monomer.

In this manner, the dispersion stability of the coloring material in the coloring material dispersion to be finally obtained, the storage stability of the coloring material dispersion, and the like can be further improved.

Examples of the hydrophobic monomer include (meth)acrylic acid alkyl esters such as methyl (meth)acrylate, ethyl (meth)acrylate, propyl (meth)acrylate, butyl (meth)acrylate, pentyl (meth)acrylate, and hexyl (meth)acrylate, and vinyl aromatic compounds such as styrene and 2-vinylnaphthalene. One or a combination of two or more selected from these monomers can be used. Among these, it is preferable that the hydrophobic monomer be at least one selected from the group consisting of butyl (meth)acrylate and styrene.

In this manner, the reactivity in the present step is further enhanced, and the dispersion stability of the coloring material in the coloring material dispersion to be finally obtained, the storage stability of the coloring material dispersion, the redispersibility of the coloring material after precipitation of the coloring material from the coloring material dispersion, and the like can be further improved.

The content of the hydrophobic monomer in the liquid phase for carrying out the polymerization reaction is not particularly limited, but the proportion of the amount of substance of the hydrophobic monomer to the total amount of substance of the hydrophobic monomer and the hydrophilic monomer in the liquid phase for carrying out the polymerization reaction is preferably 50 mol % or greater and 99 mol % or less, more preferably 60 mol % or greater and 98 mol % or less, and still more preferably 70 mol % or greater and 97 mol % or less.

In this manner, the reactivity in the present step is further enhanced, and the dispersion stability of the coloring material in the coloring material dispersion to be finally obtained, the storage stability of the coloring material dispersion, the redispersibility of the coloring material after precipitation of the coloring material from the coloring material dispersion, and the like can be further improved.

### [1-1-3] Hydrophilic Monomer

The hydrophilic monomer used in the polymerization step is a compound containing a carboxylic acid group or a sulfonic acid group in a molecule.

The form of polymerization of the hydrophilic monomer is not particularly limited as long as the hydrophilic monomer has the above-described chemical structure. Examples of the form of polymerization of the hydrophilic monomer include addition polymerization, condensation polymerization, and ring-opening polymerization. Among these, addition polymerization is preferable, and a hydrophilic monomer having a polymerizable double bond is preferable as the hydrophilic monomer.

In this manner, the dispersion stability of the coloring material in the coloring material dispersion to be finally obtained, the storage stability of the coloring material dispersion, and the like can be further improved.

Examples of the hydrophilic monomer include vinylsulfonic acid, (meth)acrylic acid, (meth)allylsulfonic acid, vinyl carboxylate, 2-acrylamido-2-methylpropanesulfonic acid, and salts thereof, and one or a combination of two or more selected from these monomers can be used. Among these, at least one selected from the group consisting of vinylsulfonic acid, (meth)acrylic acid, (meth)allylsulfonic acid, 2-acrylamido-2-methylpropanesulfonic acid, and salts thereof is preferable, and (meth)acrylic acid or (meth)allylsulfonic acid is more preferable.

In this manner, the reactivity in the present step is further enhanced, and the dispersion stability of the coloring material in the coloring material dispersion to be finally obtained, the storage stability of the coloring material dispersion, the redispersibility of the coloring material after precipitation of the coloring material from the coloring material dispersion, and the like can be further improved.

The content of the hydrophilic monomer in the liquid phase for carrying out the polymerization reaction is not particularly limited, but the proportion of the amount of substance of the hydrophilic monomer to the total amount of substance of the hydrophobic monomer and the hydrophilic monomer in the liquid phase for carrying out the polymerization reaction is preferably 1 mol % or greater and 50 mol % or less, more preferably 2 mol % or greater and 40 mol % or less, and still more preferably 3 mol % or greater and 30 mol % or less.

In this manner, the reactivity in the present step is further enhanced, and the dispersion stability of the coloring material in the coloring material dispersion to be finally obtained, the storage stability of the coloring material dispersion, the redispersibility of the coloring material after precipitation of the coloring material from the coloring material dispersion, and the like can be further improved.

The proportion of the amount of substance of the (meth)acrylic acid to the total amount of substance of all monomer components in the liquid phase for carrying out the polymerization reaction is preferably 1 mol % or greater and 49 mol % or less, more preferably 2 mol % or greater and 30 mol % or less, and still more preferably 3 mol % or greater and 20 mol % or less.

In this manner, the reactivity in the present step is further enhanced, and the dispersion stability of the coloring material in the coloring material dispersion to be finally obtained, the storage stability of the coloring material dispersion, the redispersibility of the coloring material after precipitation of the coloring material from the coloring material dispersion, and the like can be further improved.

### [1-1-4] Coloring Material

The polymerization step may be a step of performing polymerization in the liquid phase containing the organic solvent, the hydrophobic monomer, and the hydrophilic monomer, but the liquid phase for carrying out the polymerization step may further contain, for example, a coloring material.

In this manner, the dispersion resin can be more suitably attached to the surface of the coloring material. Further, for example, the coloring material mixing step described below can be omitted, and even when the coloring material mixing step is performed, the amount of the coloring material to be mixed in the coloring material mixing step can be decreased.

The coloring material will be described in detail below.

As will be described in detail below, the coloring material may be mixed after the polymerization step. In this case, the liquid phase in the polymerization step need not contain the coloring material.

### [1-1-5] Other Components

The liquid phase for carrying out the polymerization step may contain other components. Hereinafter, such components are also referred to as “other components” in section [1-1-5].

Examples of other components include monomer components other than the hydrophobic monomer and the hydrophilic monomer, polymerization initiators such as azobisisobutyronitrile, and pH adjusters.

Here, the content of water in the liquid phase for carrying out the polymerization reaction is preferably 2.0% by mass or less, more preferably 1.0% by mass or less, and still more preferably 0.5% by mass or less.

The content of other components in the liquid phase for carrying out the polymerization reaction is preferably 6.0% by mass or less and more preferably 5.0% by mass or less.

The lower limit of the content of other components is 0% by mass.

### [1-1-6] Reaction Conditions

The polymerization step may be performed under any conditions as long as the monomer components including the hydrophobic monomer and the hydrophilic monomer are polymerized.

The polymerization step may depend on the types of monomer components and the like and is typically performed by heating the liquid phase in the presence of a polymerization initiator.

The heating temperature in the polymerization step is not particularly limited, but is preferably 40° C. or higher and 90° C. or lower, more preferably 45° C. or higher and 85° C. or lower, and still more preferably 50° C. or higher and 80° C. or lower.

The reaction time in the polymerization step is not particularly limited, but is preferably 1 hour or longer and 24 hours or shorter, more preferably 2 hours or longer and 18 hours or shorter, and still more preferably 3 hours or longer and 16 hours or shorter.

Further, the polymerization step may be performed as a one-step reaction or a two- or more step reaction.

The dispersion resin obtained in the present step is a copolymer having a constituent unit A corresponding to the hydrophobic monomer and a constituent unit B corresponding to the hydrophilic monomer.

The weight-average molecular weight of the dispersion resin obtained in the above-described manner may be 5,000 or greater and less than 100,000 and is preferably 7,000 or greater and less than 60,000.

In this manner, the above-described effects are more significantly exhibited.

Further, the content of the constituent unit A corresponding to the hydrophobic monomer in all constituent monomers contained in the dispersion resin obtained in the above-described manner may be 50 mol % or greater and is preferably 50 mol % or greater and 99 mol % or less, more preferably 60 mol % or greater and 98 mol % or less, and still more preferably 70 mol % or greater and 97 mol % or less.

In this manner, the above-described effects are more significantly exhibited.

Further, it is preferable that the dispersion resin obtained by the polymerization reaction in the polymerization step satisfy the following conditions.

That is, the content of the constituent unit B corresponding to the hydrophilic monomer in all constituent monomers contained in the dispersion resin is preferably 1 mol % or greater and 50 mol % or less, more preferably 2 mol % or greater and 40 mol % or less, and still more preferably 3 mol % or greater and 30 mol % or less.

Further, the dispersity of the dispersion resin, that is, the number obtained by dividing the weight-average molecular weight Mw of the dispersion resin by the number average molecular weight Mn of the dispersion resin, is preferably 1.05 or greater and less than 2.50, more preferably 1.20 or greater and less than 2.40, and still more preferably 1.25 or greater and less than 2.35.

In this manner, the dispersion stability of the coloring material in the coloring material dispersion to be finally obtained, the storage stability of the coloring material dispersion, the redispersibility of the coloring material after precipitation of the coloring material from the coloring material dispersion, and the like can be further improved.

The dispersion resin synthesized in the above-described manner may be used in the step described below still in the state of the liquid phase of the polymerization step, but is preferably used in the step described below after being purified.

The dispersion resin may be purified by any method, and for example, the purification can be carried out in the following manner.

First, after completion of the polymerization reaction, the liquid phase serving as the reaction product is diluted with a solvent as necessary, and the dilution is added dropwise to a poor solvent with respect to the dispersion resin so that the dispersion resin is precipitated. Thereafter, the precipitated dispersion resin is separated from the liquid phase by centrifugation or the like. Next, the dispersion resin separated from the liquid phase is dried. According to such a method, the dispersion resin can be suitably purified.

For example, tetrahydrofuran or the like can be used as the diluent solvent when the purification is performed in the above-described manner, and for example, hexane or the like can be used as the poor solvent.

### [1-2] Water Mixing Step

The dispersion resin obtained in the polymerization step is mixed with water in the water mixing step.

Since such a step is provided, the content of water in the coloring material dispersion to be finally obtained can be adjusted within a suitable range even when the polymerization step is performed in a liquid phase that does not contain water or a liquid phase with a relatively low content of water. Thus, a coloring material dispersion with suitable fluidity and viscosity can be obtained. Further, the coloring material mixing step can be more suitably carried out by performing the present step before the coloring material mixing step.

The amount of water to be mixed with the dispersion resin in the present step is not particularly limited, but the amount of water to be mixed in the present step is preferably 200 parts by mass or greater and 2,000 parts by mass or less, more preferably 250 parts by mass or greater and 1,000 parts by mass or less, and still more preferably 300 parts by mass or greater and 700 parts by mass or less with respect to 100 parts by mass of the dispersion resin.

In this manner, the above-described effects are more significantly exhibited.

Further, in the present step, other components may be mixed with the dispersion resin and water.

Examples of such components include pH adjusters such as triethanolamine and ammonia.

When a pH adjuster is used in the present step, the pH of the composition obtained in the present step is preferably 5.5 or greater and 8.5 or less, more preferably 6.0 or greater and 8.0 or less, and still more preferably 6.5 or greater and 7.7 or less.

In this manner, the dispersion stability of the coloring material in the coloring material dispersion to be finally obtained, the storage stability of the coloring material dispersion, the redispersibility of the coloring material after precipitation of the coloring material from the coloring material dispersion, and the like can be further improved.

In the present step, the dispersion resin and water may be mixed with each other in two or more steps.

For example, a first treatment of mixing the dispersion resin with water, a second treatment of adding a pH adjuster to the composition obtained by the first treatment to adjust the pH thereof, and a third treatment of mixing the composition obtained by the second treatment with water may be performed in the present step.

In the present step, a heat treatment may be carried out as necessary.

The heating temperature in the present step is not particularly limited, but is preferably 40° C. or higher and 95° C. or lower, more preferably 45° C. or higher and 90° C. or lower, and still more preferably 50° C. or higher and 85° C. or lower.

### [1-3] Coloring Material Mixing Step

The dispersion resin obtained in the polymerization step is mixed with the coloring material in the coloring material mixing step.

In this manner, a coloring material dispersion containing a sufficient content of the coloring material can be obtained even when the previous polymerization step is performed in a liquid phase that does not contain the coloring material or in a liquid phase with a small content of the coloring material. For this reason, in the polymerization step, a decrease in the reaction rate of the target polymerization reaction and the progress of side reactions involving the coloring material, which are not preferable, can be effectively prevented.

Particularly, according to the present embodiment, the composition obtained in the water mixing step described above, that is, the composition containing the dispersion resin and water is mixed with the coloring material. In other words, according to the present embodiment, the coloring material mixing step is performed after the water mixing step.

In this manner, the dispersion resin can be more uniformly mixed with the coloring material, and thus the dispersion resin can be more suitably attached to the surface of the coloring material.

Any coloring material can be used as the coloring material as long as the coloring material can be contained in a dispersed state in the coloring material dispersion to be finally obtained, and examples thereof include acid dyes, reactive dyes, disperse dyes, sublimation dyes, and pigments. Among these, disperse dyes are preferable.

When a disperse dye is used as the coloring material, the above-described problems occur significantly in some cases. In contrast, in the present disclosure, the redispersibility can be improved and occurrence of the above-described problems can be effectively prevented even when a disperse dye is used as the coloring material. That is, the effects of the present disclosure are more significantly exhibited when the coloring material is a disperse dye.

The disperse dye is not particularly limited, and specific examples thereof are as follows.

Examples of yellow disperse dyes include C.I. Disperse Yellow 3, 4, 5, 7, 9, 13, 23, 24, 30, 33, 34, 42, 44, 49, 50, 51, 54, 56, 58, 60, 63, 64, 66, 68, 71, 74, 76, 79, 82, 83, 85, 86, 88, 90, 91, 93, 98, 99, 100, 104, 108, 114, 116, 118, 119, 122, 124, 126, 135, 140, 141, 149, 160, 162, 163, 164, 165, 179, 180, 182, 183, 184, 186, 192, 198, 199, 202, 204, 210, 211, 215, 216, 218, 224, 227, 231, and 232.

Examples of orange disperse dyes include C.I. Disperse Orange 1, 3, 5, 7, 11, 13, 17, 20, 21, 25, 29, 30, 31, 32, 33, 37, 38, 42, 43, 44, 45, 46, 47, 48, 49, 50, 53, 54, 55, 56, 57, 58, 59, 61, 66, 71, 73, 76, 78, 80, 89, 90, 91, 93, 96, 97, 119, 127, 130, 139, and 142.

Examples of red disperse dyes include C.I. Disperse Red 1, 4, 5, 7, 11, 12, 13, 15, 17, 27, 43, 44, 50, 52, 53, 54, 55, 56, 58, 59, 60, 65, 72, 73, 74, 75, 76, 78, 81, 82, 86, 88, 90, 91, 92, 93, 96, 103, 105, 106, 107, 108, 110, 111, 113, 117, 118, 121, 122, 126, 127, 128, 131, 132, 134, 135, 137, 143, 145, 146, 151, 152, 153, 154, 157, 159, 164, 167, 169, 177, 179, 181, 183, 184, 185, 188, 189, 190, 191, 192, 200, 201, 202, 203, 205, 206, 207, 210, 221, 224, 225, 227, 229, 239, 240, 257, 258, 277, 278, 279, 281, 288, 298, 302, 303, 310, 311, 312, 320, 324, and 328.

Examples of violet disperse dyes include C.I. Disperse Violet 1, 4, 8, 23, 26, 27, 28, 31, 33, 35, 36, 38, 40, 43, 46, 48, 50, 51, 52, 56, 57, 59, 61, 63, 69, and 77.

Examples of green disperse dyes include C.I. Disperse Green 9.

Examples of brown disperse dyes include C.I. Disperse Brown 1, 2, 4, 9, 13, and 19.

Examples of blue disperse dyes include C.I. Disperse Blue 3, 7, 9, 14, 16, 19, 20, 26, 27, 35, 43, 44, 54, 55, 56, 58, 60, 62, 64, 71, 72, 73, 75, 79, 81, 82, 83, 87, 91, 93, 94, 95, 96, 102, 106, 108, 112, 113, 115, 118, 120, 122, 125, 128, 130, 139, 141, 142, 143, 146, 148, 149, 153, 154, 158, 165, 167, 171, 173, 174, 176, 181, 183, 185, 186, 187, 189, 197, 198, 200, 201, 205, 207, 211, 214, 224, 225, 257, 259, 267, 268, 270, 284, 285, 287, 288, 291, 293, 295, 297, 301, 315, 330, and 333.

Examples of black disperse dyes include C.I. Disperse Black 1, 3, 10, and 24.

In the present disclosure, for example, one or a combination of two or more selected from the coloring materials described above can be used.

### [1-4] Coloring Material Crushing Step

The coloring material is crushed in the liquid containing water, the coloring material, and the dispersion resin in the coloring material crushing step.

In this manner, the particle diameter of the coloring material can be decreased, and the dispersion resin can be more suitably attached to the surfaces of the coloring material particles. As a result, the dispersion stability of the coloring material in the coloring material dispersion to be finally obtained, the storage stability of the coloring material dispersion, the redispersibility of the coloring material after precipitation of the coloring material from the coloring material dispersion, and the like can be further improved.

The present step can be suitably performed using, for example, a ball mill, a bead mill, or the like.

In the present specification, “average particle diameter” refers to the average particle diameter on a volume basis. For example, the average particle diameter can be determined by analyzing a dispersion obtained by adding a sample to methanol and dispersing the sample therein with an ultrasonic disperser for 3 minutes, by using a coulter counter method particle size distribution measuring instrument (TA-II type, manufactured by COULTER ELECTRONICS, INC.) with an aperture of 50 μm.

### [1-5] Ink Preparation Step

In the ink preparation step, the liquid composition obtained by the coloring material crushing step is mixed with water and an organic solvent containing two or more hydroxyl and/or ether groups in a molecule to obtain a coloring material dispersion used as an ink for ink jet recording.

In this manner, the moisture retaining properties of the coloring material dispersion used as an ink for ink jet recording can be improved, and thus drying of the coloring material dispersion on or in an ink jet head or the like after ejection of the coloring material dispersion by the ink jet method, unintentional precipitation of the solid content from the coloring material dispersion due to drying, and the like can be more effectively prevented. The viscosity of the coloring material dispersion can be more suitably adjusted. Therefore, the ejection stability of the coloring material dispersion in the ink jet method can be further improved.

The organic solvent used in the present step may contain two or more hydroxyl and/or ether groups in a molecule, but it is preferable that the organic solvent contain the same compound as the organic solvent used in the polymerization step.

In this manner, the dispersion stability of the coloring material in the coloring material dispersion to be finally obtained, the storage stability of the coloring material dispersion, the redispersibility of the coloring material after precipitation of the coloring material from the coloring material dispersion, and the like can be further improved.

### [2] Coloring Material Dispersion

Next, the coloring material dispersion according to the present disclosure will be described.

The coloring material dispersion according to the present disclosure contains water, the coloring material, and the dispersion resin described above.

For example, the coloring material dispersion according to the present disclosure may be directly used as an ink or may be used as a raw material of an ink. Further, the coloring material dispersion according to the present disclosure may also be used as a coating material or the like.

Further, the coloring material dispersion according to the present disclosure preferably contains an organic solvent containing two or more hydroxyl and/or ether groups in a molecule and more preferably an organic solvent containing the same compound as the compound used in the polymerization step described above.

In this manner, the dispersion stability of the coloring material in the coloring material dispersion, the storage stability of the coloring material dispersion, the redispersibility of the coloring material after precipitation of the coloring material from the coloring material dispersion, and the like can be further improved.

It is preferable that the coloring material dispersion according to the present disclosure and each component constituting the coloring material dispersion according to the present disclosure satisfy the same conditions as described above.

In this manner, the same effects as described above can be obtained.

The content of the coloring material in the coloring material dispersion according to the present disclosure is not particularly limited, but is preferably 1.0% by mass or greater and 50% by mass or less and more preferably 2.5% by mass or greater and 30% by mass or less.

In this manner, the content of the coloring material in the coloring material dispersion can be set to be sufficiently high, and the dispersion stability of the coloring material in the coloring material dispersion, the storage stability of the coloring material dispersion, the redispersibility of the coloring material after precipitation of the coloring material from the coloring material dispersion, and the like can be further improved.

Particularly, when the coloring material dispersion according to the present disclosure itself is an ink for ink jet recording, the content of the coloring material in the coloring material dispersion is preferably 1.0% by mass or greater and 8.0% by mass or less and more preferably 2.5% by mass or greater and 6.0% by mass or less.

Further, when the coloring material dispersion according to the present disclosure is a coloring material dispersion used for preparation of an ink for ink jet recording, that is, a coloring material dispersion or a coating material in a narrow sense, the content of the coloring material in the coloring material dispersion is preferably 7% by mass or greater and 50% by mass or less and more preferably 10% by mass or greater and 30% by mass or less.

The content of the dispersion resin in the coloring material dispersion according to the present disclosure is not particularly limited, but is preferably 0.1% by mass or greater and 25% by mass or less and more preferably 0.5% by mass or greater and 15% by mass or less.

In this manner, the dispersion stability of the coloring material in the coloring material dispersion, the storage stability of the coloring material dispersion, the redispersibility of the coloring material after precipitation of the coloring material from the coloring material dispersion, and the like can be further improved.

Particularly, when the coloring material dispersion according to the present disclosure itself is an ink for ink jet recording, the content of the dispersion resin in the coloring material dispersion is preferably 0.1% by mass or greater and 4% by mass or less and more preferably 0.2% by mass or greater and 3% by mass or less.

Further, when the coloring material dispersion according to the present disclosure is a coloring material dispersion used for preparation of an ink for ink jet recording, that is, a coloring material dispersion or a coating material in a narrow sense, the content of the dispersion resin in the coloring material dispersion is preferably 0.7% by mass or greater and 25% by mass or less and more preferably 1.0% by mass or greater and 15% by mass or less.

When the coloring material dispersion according to the present disclosure itself is an ink for ink jet recording, the content of the organic solvent in the coloring material dispersion is not particularly limited, but is preferably 2% by mass or greater and 20% by mass or less and more preferably 3% by mass or greater and 10% by mass or less.

Further, when the coloring material dispersion according to the present disclosure contains the organic solvent, the proportion of an organic solvent containing a hydroxyl group in a molecule in all organic solvents contained in the coloring material dispersion is preferably 33% by mass or greater and more preferably 50% by mass or greater.

In this manner, the redispersibility of the coloring material after precipitation of the coloring material from the coloring material dispersion can be further improved.

0.10≤XD/XC≤1.00 is preferable, 0.20≤XD/XC≤0.70 is more preferable, and 0.30≤XD/XC≤0.60 is still more preferable, where XC [% by mass] is the content of the coloring material in the coloring material dispersion according to the present disclosure, and XD [% by mass] is the content of the dispersion resin in the coloring material dispersion according to the present disclosure.

In this manner, the content of the coloring material in the coloring material dispersion can be set to be sufficiently high, and the dispersion stability of the coloring material in the coloring material dispersion, the storage stability of the coloring material dispersion, the redispersibility of the coloring material after precipitation of the coloring material from the coloring material dispersion, and the like can be further improved.

The coloring material dispersion according to the present disclosure may contain other components. Hereinafter, such components are also referred to as “other components” in section [2].

Examples of other components include pH adjusters, chelating agents, preservatives, fungicides, rust inhibitors, flame retardants, dispersants other than the above-described dispersion resin, surfactants, antioxidants, ultraviolet absorbing agents, oxygen absorbing agents, dissolution assistants, and penetrating agents.

Examples of chelating agents include ethylenediaminetetraacetates. Further, examples of preservatives and fungicides include sodium benzoate, sodium pentachlorophenol, sodium 2-pyridinethiol-1-oxide, sodium sorbate, sodium dehydroacetate, 1,2-dibenzisothiazolin-3-one, and 4-chloro-3-methylphenol. Further, examples of rust inhibitors include benzotriazole.

For example, a compound having an isothiazoline ring structure in a molecule can be suitably used as the preservative or the fungicide.

For example, various surfactants such as anionic surfactants, cationic surfactants, and nonionic surfactants can be used as the surfactant.

The content of other components is preferably 3.0% by mass or less and more preferably 2.0% by mass or less.

The lower limit of the content of other components is 0% by mass.

When the coloring material dispersion according to the present disclosure contains other components, such components may be added, for example, in the above-described steps or in steps other than the above-described steps.

The viscosity of the coloring material dispersion according to the present disclosure at 25° C. is preferably 2 mPa·s or greater and 10 mPa·s or less, more preferably 3 mPa·s or greater and 8 mPa·s or less, and still more preferably 4 mPa·s or greater and 6 mPa·s or less.

In this manner, the ejection stability of the coloring material dispersion according to the present disclosure in the ink jet method can be further improved.

The viscosity can be measured by reading the viscosity at 25° C. when the shear velocity reaches 10 [s⁻¹] using a viscoelasticity tester (for example, VISCO 6800, manufactured by Atago Co., Ltd.).

Herein, preferred embodiments of the present disclosure have been described, but the present disclosure is not limited thereto.

For example, in the embodiment described above, the method of sequentially performing the polymerization step, the water mixing step, the coloring material mixing step, the coloring material crushing step, and the ink preparation step has been described as a representative example. However, in the method of producing the coloring material dispersion according to the present disclosure, at least one of the steps other than the polymerization step may be omitted, the order of the steps may be changed, or the treatments described as being performed in a plurality of steps may be performed in a single step. More specifically, when the coloring material dispersion is not an ink, for example, when the coloring material dispersion is not an ink but a coloring material dispersion used for preparation of an ink, the above-described ink preparation step may be omitted.

Further, the method of producing the coloring material dispersion according to the present disclosure may have a configuration other than the configuration described above.

### EXAMPLES

Hereinafter, specific examples of the present disclosure will be described.

### [3] Preparation of Coloring Material Dispersion

### Dispersion 1

To a side-arm flask were added 16 parts by mass of butyl acrylate serving as a hydrophobic monomer, 16 parts by mass of sodium methallylsulfonate serving as a hydrophilic monomer, 5 parts by mass of acrylic acid serving as a hydrophilic monomer, 2 parts by mass of 2-{[carboxymethyl)sulfanylthiocarbonyl]sulfanyl}propanoic acid, and 1 part by mass of azobisisobutyronitrile serving as a polymerization initiator. Further, 60 parts by mass of 1,2-butanediol serving as an organic solvent was added to the flask to dissolve each component, and a Dimroth condenser was attached to the flask. Thereafter, the solution was allowed to react at 75° C. for 6 hours while being stirred with a stirrer.

After completion of the reaction, the reaction product was diluted with tetrahydrofuran and added dropwise to hexane to precipitate a yellow solid. The yellow precipitate was recovered by centrifugation and vacuum-dried at 50° C. for 10 hours, thereby obtaining 50 parts by mass of a dispersion resin as a copolymer. The weight-average molecular weight of the resulting dispersion resin was 8,200.

Next, a 1 L recovery flask was set, 15 parts by mass of the dispersion resin as a copolymer obtained in the above-described manner and 70 parts by mass of pure water were added to the flask, and a Dimroth condenser was attached to the flask. Thereafter, the solution was heated at 80° C. while being stirred with a stirrer. Further, triethanolamine was added to the solution until the pH thereof reached 7.6, and the amount thereof was adjusted to 100 parts by mass with pure water. The solution was cooled to 25° C., and the dissolved aqueous solution was obtained as a varnish solution.

Next, 50 parts by mass of the varnish solution, 15 parts by mass of C.I. Disperse Yellow 232 serving as a water-insoluble coloring material, and 35 parts by mass of pure water were added and crushed by a bead mill for 1 hour, thereby obtaining a coloring material dispersion containing 6% by mass of the copolymer and 12% by mass of the coloring material.

### Dispersion 2

A coloring material dispersion was produced in the same manner as the dispersion 1 except that a mixed solvent of 30 parts by weight of triethylene glycol monomethyl ether and 30 parts by weight of THF was used as the organic solvent in place of 60 parts by weight of 1,2-butanediol.

### Dispersion 3

A coloring material dispersion was produced in the same manner as the dispersion 1 except that propylene glycol was used as the organic solvent in place of 1,2-butanediol.

### Dispersion 4

A coloring material dispersion was produced in the same manner as the dispersion 1 except that 21 parts by mass of styrene and 16 parts by mass of acrylic acid were used in place of 16 parts by mass of butyl acrylate, 16 parts by mass of sodium methallylsulfonate, and 5 parts by mass of acrylic acid.

### Dispersion 5

A coloring material dispersion was produced in the same manner as the dispersion 2 except that 21 parts by mass of styrene and 16 parts by mass of acrylic acid were used in place of 16 parts by mass of butyl acrylate, 16 parts by mass of sodium methallylsulfonate, and 5 parts by mass of acrylic acid.

### Dispersion 6

A coloring material dispersion was produced in the same manner as the dispersion 3 except that 21 parts by mass of styrene and 16 parts by mass of acrylic acid were used in place of 16 parts by mass of butyl acrylate, 16 parts by mass of sodium methallylsulfonate, and 5 parts by mass of acrylic acid.

### Dispersion 7

A coloring material dispersion was produced in the same manner as the dispersion 1 except that 16 parts by mass of butyl acrylate, 16 parts by mass of 2-acrylamido-2-methylpropanesulfonic acid, and 5 parts by mass of acrylic acid were used in place of 16 parts by mass of butyl acrylate, 16 parts by mass of sodium methallylsulfonate, and 5 parts by mass of acrylic acid.

### Dispersion 8

A coloring material dispersion was produced in the same manner as the dispersion 2 except that 16 parts by mass of butyl acrylate, 16 parts by mass of 2-acrylamido-2-methylpropanesulfonic acid, and 5 parts by mass of acrylic acid were used in place of 16 parts by mass of butyl acrylate, 16 parts by mass of sodium methallylsulfonate, and 5 parts by mass of acrylic acid.

### Dispersion 9

A coloring material dispersion was produced in the same manner as the dispersion 3 except that 16 parts by mass of butyl acrylate, 16 parts by mass of 2-acrylamido-2-methylpropanesulfonic acid, and 5 parts by mass of acrylic acid were used in place of 16 parts by mass of butyl acrylate, 16 parts by mass of sodium methallylsulfonate, and 5 parts by mass of acrylic acid.

### Dispersion 10

A coloring material dispersion was produced in the same manner as the dispersion 1 except that tetrahydrofuran was used as the organic solvent in place of 1,2-butanediol.

### Dispersion 11

A coloring material dispersion was produced in the same manner as the dispersion 4 except that tetrahydrofuran was used as the organic solvent in place of 1,2-butanediol.

The conditions for the dispersion resins contained in the coloring material dispersions obtained in the examples and the comparative examples are collectively listed in Table 1, and the conditions for the coloring material dispersions obtained in the examples and the comparative examples are collectively listed in Table 2. In the tables, butyl acrylate is denoted as “BA”, styrene is denoted as “St”, acrylic acid is denoted as “AA”, sodium methallylsulfonate is denoted as “NaMPS”, 2-acrylamido-2-methylpropanesulfonic acid is denoted as “ATBS”, C.I. Disperse Yellow 232 is denoted as “DY232”, 1,2-butanediol is denoted as “1,2-BD”, ethylene glycol monomethyl ether is denoted as “EGME”, propylene glycol is denoted as “PG”, tetrahydrofuran is denoted as “THF”, the weight-average molecular weight is denoted as Mw, and the number average molecular weight is denoted as Mn.

TABLE 1
Table 1

| | Content [mol %] | | | | | | |
|---|---|---|---|---|---|---|---|
| | Hydrophobic monomer | | Hydrophilic monomer | | | | |
| | BA | St | AA | NaMPS | ATBS | Mw | Mw/Mn |
| Dispersion 1 | 74 | — | 8 | 18 | — | 32000 | 2.34 |
| Dispersion 2 | 76 | — | 11 | 13 | — | 14000 | 1.63 |
| Dispersion 3 | 70 | — | 11 | 19 | — | 57000 | 2.08 |
| Dispersion 4 | — | 58 | 42 | — | — | 14000 | 1.40 |
| Dispersion 5 | — | 56 | 44 | — | — | 5000 | 1.25 |
| Dispersion 6 | — | 59 | 41 | — | — | 13000 | 1.51 |
| Dispersion 7 | 81 | — | 8 | — | 11 | 12000 | 1.57 |
| Dispersion 8 | 86 | — | 5 | — | 9 | 22000 | 1.94 |
| Dispersion 9 | 78 | — | 9 | — | 13 | 18000 | 1.82 |
| Dispersion 10 | 78 | — | 10 | 12 | — | 10000 | 1.88 |
| Dispersion 11 | — | 54 | 46 | — | — | 10000 | 1.46 |

### [4] Production of Ink Composition

The dispersions prepared in section [3] described above were mixed with other components to obtain the compositions listed in Table 2, thereby producing ink compositions of Examples 1 to 9 and Comparative Examples 1 and 2.

In Table 2, C.I. Disperse Yellow 232 is denoted as “DY232”, 1,2-butanediol is denoted as “1,2-BD”, triethylene glycol monomethyl ether is denoted as “TEGMME”, propylene glycol is denoted as “PP”, 1,2-diethylene glycol is denoted as “1,2-DEG”, carboxymethylcellulose sodium salt (manufactured by FUJIFILM Wako Pure Chemical Corporation) is denoted as “CMCNa”, BYK-348 (manufactured by BYK Japan KK), which is a silicone-based surfactant, is denoted as “BYK-348”, and triethanolamine is denoted as “TEA”.

TABLE 2
Table 2

| | Coloring | | | | | | | Other | | pH | |
|---|---|---|---|---|---|---|---|---|---|---|---|
| | material | | | Organic solvent | | | | resins | Surfactant | adjuster | |
| | DY232 | Dispersion resin | | 1,2-BD | TEGMME | PP | 1,2-DEG | CMCNa | BYK-348 | TEA | Water |
| | Content | | Content | Content | Content | Content | Content | Content | Content | Content | Content |
| | [% by | | [% by | [% by | [% by | [% by | [% by | [% by | [% by | [% by | [% by |
| | mass] | Type | mass] | mass] | mass] | mass] | mass] | mass] | mass] | mass] | mass] |
| Example 1 | 3.0 | Dispersion | 1.5 | 3.0 | — | — | 10.0 | 1.0 | 0.3 | 1.0 | 80.2 |
| | | resin in | | | | | | | | | |
| | | dispersion 1 | | | | | | | | | |
| Example 2 | 3.0 | Dispersion | 1.5 | — | 3.0 | — | 10.0 | 1.0 | 0.3 | 1.0 | 80.2 |
| | | resin in | | | | | | | | | |
| | | dispersion 2 | | | | | | | | | |
| Example 3 | 3.0 | Dispersion | 1.5 | — | — | 3.0 | 10.0 | 1.0 | 0.3 | 1.0 | 80.2 |
| | | resin in | | | | | | | | | |
| | | dispersion 3 | | | | | | | | | |
| Example 4 | 3.0 | Dispersion | 1.5 | 3.0 | — | — | 10.0 | 1.0 | 0.3 | 1.0 | 80.2 |
| | | resin in | | | | | | | | | |
| | | dispersion 4 | | | | | | | | | |
| Example 5 | 3.0 | Dispersion | 1.5 | — | 3.0 | — | 10.0 | 1.0 | 0.3 | 1.0 | 80.2 |
| | | resin in | | | | | | | | | |
| | | dispersion 5 | | | | | | | | | |
| Example 6 | 3.0 | Dispersion | 1.5 | — | — | 3.0 | 10.0 | 1.0 | 0.3 | 1.0 | 80.2 |
| | | resin in | | | | | | | | | |
| | | dispersion 6 | | | | | | | | | |
| Example 7 | 3.0 | Dispersion | 1.5 | 3.0 | — | — | 10.0 | 1.0 | 0.3 | 1.0 | 80.2 |
| | | resin in | | | | | | | | | |
| | | dispersion 7 | | | | | | | | | |
| Example 8 | 3.0 | Dispersion | 1.5 | — | 3.0 | — | 10.0 | 1.0 | 0.3 | 1.0 | 80.2 |
| | | resin in | | | | | | | | | |
| | | dispersion 8 | | | | | | | | | |
| Example 9 | 3.0 | Dispersion | 1.5 | — | — | 3.0 | 10.0 | 1.0 | 0.3 | 1.0 | 80.2 |
| | | resin in | | | | | | | | | |
| | | dispersion 9 | | | | | | | | | |
| Comparative | 3.0 | Dispersion | 1.5 | 3.0 | — | — | 10.0 | 1.0 | 0.3 | 1.0 | 80.2 |
| Example 1 | | resin in | | | | | | | | | |
| | | dispersion 10 | | | | | | | | | |
| Comparative | 3.0 | Dispersion | 1.5 | 3.0 | — | — | 10.0 | 1.0 | 0.3 | 1.0 | 80.2 |
| Example 2 | | resin in | | | | | | | | | |
| | | dispersion 11 | | | | | | | | | |

### [5] Evaluation

The ink compositions obtained in the examples and the comparative examples were evaluated in the following manner.

### [5-1] Change in Particle Size Distribution

First, 30 mL of each of the ink compositions obtained in the examples and the comparative examples was added to a predetermined container and allowed to stand in an environment of 60° C. for 5 days.

Thereafter, the average particle diameter of the coloring material contained in each coloring material dispersion after standing in an environment of 60° C. for 5 days was determined by performing measurement with a coulter counter method particle size distribution measuring instrument (TA-II type, manufactured by COULTER ELECTRONICS, INC.) using an aperture of 50 μm, and the evaluation was performed based on the following evaluation criteria. A lower rate of increase in average particle diameter indicates that the dispersion stability of the coloring material and the storage stability of the coloring material dispersion are higher. A rank of B or higher indicates a satisfactory level.

A: The rate of increase in average particle diameter was less than 10%.

B: The rate of increase in average particle diameter was 10% or greater and less than 30%.

C: The rate of increase in average particle diameter was 30% or greater.

### [5-2] Viscosity

First, the viscosity of each of the ink compositions obtained in the examples and the comparative examples when the shear velocity reached 10 [s⁻¹] at 25° C. was determined using a viscoelasticity tester (MCR-300, manufactured by Physica-Anton Paar), and the evaluation was performed based on the following evaluation criteria. A rank of B or higher indicates a satisfactory level.

A: The viscosity at a shear velocity of 10 [s⁻¹] was 4 mPa·s or greater and 6 mPa·s or less.

B: The viscosity at a shear velocity of 10 [s⁻¹] was greater than 6 mPa·s and 10 mPa·s or less.

C: The viscosity at a shear velocity of 10 [s⁻¹] was greater than 10 mPa·s.

### [5-3] Change in Viscosity

First, 30 mL of each of the ink compositions obtained in the examples and the comparative examples was added to a predetermined container and allowed to stand in an environment of 60° C. for 5 days.

Thereafter, the viscosity of the ink composition when the shear velocity reached 10 [s⁻¹] at 25° C. was determined using a viscoelasticity tester (MCR-300, manufactured by Physica-Anton Paar), and the evaluation was performed based on the following evaluation criteria. A rank of B or higher indicates a satisfactory level.

A: The viscosity at a shear velocity of 10 [s⁻¹] was 4 mPa·s or greater and 6 mPa·s or less.

B: The viscosity at a shear velocity of 10 [s⁻¹] was greater than 6 mPa·s and 10 mPa·s or less.

C: The viscosity at a shear velocity of 10 [s⁻¹] was greater than 10 mPa·s.

### [5-4] Redispersibility

First, each of the ink compositions obtained in the examples and the comparative examples was added dropwise onto a slide glass, dried, and solidified. Further, the slide glass was immersed in a sample bottle containing ink water while sufficiently paying attention not to stir the ink water. The behavior of the redispersion of the solid matter was visually inspected, and the evaluation was performed based on the following criteria. A rank of B or higher indicates a satisfactory level. A liquid having a composition obtained by excluding the coloring material and the dispersion resin from the ink composition in each of the examples and the comparative examples was used as the ink water.

A: The solid matter was dispersed in the ink water.

B: The solid matter was slightly dispersed in the ink water.

C: The solid matter was not dispersed in the ink water.

The results and the average particle diameter of the coloring material contained in each ink composition are collectively listed in Table 3.

TABLE 3
Table 3

| | Average | | | | |
|---|---|---|---|---|---|
| | particle | Change in | | | |
| | diameter | particle size | Viscos- | Change in | Redispers- |
| | [nm] | distribution | ity | viscosity | ibility |
| Example 1 | 227 | A | B | A | A |
| Example 2 | 180 | B | A | A | A |
| Example 3 | 207 | A | A | B | A |
| Example 4 | 223 | A | A | A | A |
| Example 5 | 232 | B | B | A | A |
| Example 6 | 224 | B | A | B | A |
| Example 7 | 219 | B | A | B | A |
| Example 8 | 214 | A | A | A | A |
| Example 9 | 222 | A | A | B | A |
| Comparative | 247 | C | C | B | C |
| Example 1 | | | | | |
| Comparative | 238 | C | B | C | C |
| Example 2 | | | | | |

As evident from Table 3, excellent results were obtained in the present disclosure. In contrast, satisfactory results were not obtained in the comparative examples.

What is claimed is:

1. A method of producing a coloring material dispersion that contains water and a coloring material, the method comprising:
a polymerization step of performing a polymerization reaction in a liquid phase that contains an organic solvent containing two or more hydroxyl and/or ether groups in a molecule, a hydrophobic monomer having an aromatic ring or a (meth)acrylic acid alkyl ester structure, and a hydrophilic monomer containing a carboxylic acid group or a sulfonic acid group to synthesize a dispersion resin, wherein
the dispersion resin has a weight-average molecular weight of 5,000 or greater and less than 100,000, and
a content of a constituent unit A corresponding to the hydrophobic monomer in all constituent monomers contained in the dispersion resin is 50 mol % or greater.

2. The method of producing a coloring material dispersion according to claim 1, wherein
the organic solvent is at least one selected from the group consisting of glycol ethers and polyhydric alcohols.

3. The method of producing a coloring material dispersion according to claim 1, wherein
both the hydrophobic monomer and the hydrophilic monomer have a polymerizable double bond.

4. The method of producing a coloring material dispersion according to claim 1, wherein
the hydrophobic monomer is at least one selected from the group consisting of butyl (meth)acrylate and styrene.

5. The method of producing a coloring material dispersion according to claim 1, wherein
the hydrophilic monomer is at least one selected from the group consisting of vinylsulfonic acid, (meth)acrylic acid, (meth)allylsulfonic acid, 2-acrylamido-2-methylpropanesulfonic acid, and salts thereof.

6. The method of producing a coloring material dispersion according to claim 1, wherein
a content of a constituent unit B corresponding to the hydrophilic monomer in all constituent monomers contained in the dispersion resin is 1 mol % or greater and 50 mol % or less.

7. The method of producing a coloring material dispersion according to claim 1, wherein
the dispersion resin has a dispersity of 1.05 or greater and less than 2.50.

8. The method of producing a coloring material dispersion according to claim 1, wherein
the dispersion resin has a weight-average molecular weight of 7,000 or greater and less than 60,000.

9. The method of producing a coloring material dispersion according to claim 1, wherein
the coloring material is a disperse dye.

10. The method of producing a coloring material dispersion according to claim 1, further comprising:
a water mixing step of mixing the dispersion resin with the water.

11. The method of producing a coloring material dispersion according to claim 1, further comprising:
a coloring material mixing step of mixing the dispersion resin with the coloring material.

12. The method of producing a coloring material dispersion according to claim 1, further comprising:
a coloring material crushing step of crushing the coloring material in a liquid containing the water, the coloring material, and the dispersion resin.

13. The method of producing a coloring material dispersion according to claim 12, further comprising:
an ink preparation step of mixing a liquid composition obtained by the coloring material crushing step with water and an organic solvent containing two or more hydroxyl and/or ether groups in a molecule to obtain a coloring material dispersion used as an ink for ink jet recording.
